(19) United States
(12) Patent Application Publication
(10) Pub. No.: US 2012/0102817 A1
(43) Pub. Date: May 3, 2012

(54) Environmentally friendly granite fishing lures, jigs, weights, and inserts

(76) Inventor: Kenneth S. Klaput, Virginia Beach, VA (US)

(21) Appl. No.: 12/925,875

(22) Filed: Nov. 2, 2010

(51) Int. Cl. A01K 85/00

(52) U.S. Cl. 43/42.32; 43/42.39

(57) ABSTRACT

Fishing lures, weights, and inserts having bodies formed from natural granite chosen from granites having differing densities and colors. Surfaces of the body may selectively be polished or left unpolished. Fishing weights and inserts depend on a high density material, commonly lead, to provide mass to help sink an otherwise buoyant structure to a desired depth. Lead, a toxic material and a hazard when released into the environment, is completely eliminated by the granite structures. The porosity, especially of light colored granite, allows its use as a delivery vehicle for fish attractants that are readily absorbed into the relatively porous material, especially when such material is left unpolished.

### FIELD OF THE INVENTION

The invention pertains to fishing tackle and, more particularly, to fishing lures, jigs, weights, and inserts formed from granite.

### BACKGROUND OF THE INVENTION

A fishing lure is an object typically attached to the end of a fishing line. Fishing lures generally are designed to resemble and move like an insect, worm, bait fish, etc. The size, shape, color, generated sound or vibration, and movement of a fishing lure are optimized to attract a desired species of fish and encouraging such fish to strike or bite one or more hooks typically attached to the body of the fishing lure. Fishing lures are generally equipped with at least a single, double, or triple hook that is used to hook and retain a fish when they attack the fishing lure.

Lures are deployed in fish inhabited water using many angling techniques, for example casting. The use of lures for fishing dates back to antiquity. The earliest lures were formed from bone, antler, or later, from copper or bronze. The earliest known metal hooks were formed from bronze. Modern fishing lures were first commercially produced in the early 1900s and were typically formed from wood and later plastic.

A typical fishing lure has a central body, sometimes formed from multiple articulated portions. A means for attaching the lure to a fishing line is typically provided at one end of a body while one or more hooks are generally attached at an opposite end of the body. The shape of the body is chosen so as to control the movement of the fishing lure through the water to simulate the natural movement of a small fish, worm, or insect considered attractive to the target fish population.

To control fishing lure movement and or running depth, weights (i.e., “sinks”) are sometimes attached to or embedded in the fishing lure body. In the prior art, lead was commonly used to provide the necessary weight. As environmentalists are now well aware, lead is a highly toxic substance that when released into the water is a major source of pollution. Further, it has proven difficult to cause externally attached sinks to properly position themselves to achieve the desired movement from a fishing lure to which they are attached.

Other pollutants often associated with fishing lures are found in paints, tapes, or other applied materials used to decorate the lures.

Many of the same problems associated with lures are also plague jigs and other similar fishing tackle.

### Discussion of the Related Art

There are several attempts to solve one or more of the aforementioned problems to be found in the prior art. There are, for example, fishing lures formed from natural materials such as those disclosed by U.S. Pat. No. 4,663,881 for DISINTEGRATING CASTING WEIGHT AND FISH ATTRACTOR, issued May 12, 1987 to John I. Follett teaches a water soluble weight that is attachable to a fishing line. The FOLLETT weight is formed from a mixture of water, soil (preferably a silt-clay mixture and 10-30 mesh stone. The mixture is molded and dried.

U.S. Pat. No. 5,715,627 for NATURAL ROCK FISHING LURE, issued Feb. 10, 1998 to Phillip Jones discloses a fishing lure having a natural stone body. The stone body has multiple fracture surfaces randomly oriented.

U.S. Pat. No. 6,076,297 for ENVIRONMENTALLY SAFE WEIGHTING ATTACHMENT FOR A FISHING LINE, issued Jun. 20, 2000 to Robert Lippincott provides a weight formed from a mixture of natural stone and an elastomer.

Published United States Patent Application 2003/0046857 for SCENTED SINKER, published Mar. 13, 2003 upon application by John E. Paulsen et al. teaches a scented fishing weight having a housing and a porous shell.

Published United States Patent Application 2006/0070291 for ANGLING RIG, published Apr. 6, 2006 upon application by Simon Alexander Pomeroy discloses an angling rig formed from a pebble of natural stone.

Published United States Patent Application 2008/0000143 for FISHING LURES, published Jan. 3, 2008 upon application by William McBurney shows a fishing lure formed from a precious metal and having multiple stones set into the body.

None of the patents and published patent applications, taken singly, or in any combination are seen to teach or suggest the novel environmentally friendly granite fishing lures, weights, and inserts of the present invention.

### SUMMARY OF THE INVENTION

In accordance with the present invention there is provided fishing lures, jigs, weights, and inserts formed from natural granite. Granites of differing densities and porosities may or may not be polished.

Fishing lures are typically highly reflective structures. Forming fishing lures from polished granite allows natural reflection and refraction, primarily from the quartz and other reflective constituents of the granite without needing artificial treatments from paint, tape, or other applications that may be toxic or otherwise harmful to the environment.

Fishing weights and inserts depend on a high density material, commonly lead, to provide mass to help sink an otherwise buoyant structure to a desired depth. As is well known lead is a toxic material and a hazard when released into the environment. The porosity, especially of light colored granite, allows its use as a delivery vehicle for fish attractants that are readily absorbed into the relatively porous material, especially when such material is left unpolished.

The novel granite fishing lures, jigs, weights, and inserts provided are attractive, durable, functional, and completely non-toxic.

Porous forms of granite, for example unpolished, lighter colored granite may be died any desired color using non-toxic, organic dye material, for example food coloring. The color is absorbed into the stone and then retained by polishing the surface. A luminescent material is especially useful for deep sea fishing applications where light from the surface is greatly diminished.

It is, therefore, an object of the invention to provide fishing lures, jigs, weights, and inserts formed from granite that are environmentally friendly (i.e., non-toxic).

It is another object of the invention to provide fishing lures, jigs, weights, and inserts formed from granite that are attractive and durable.

It is an additional object of the invention to provide fishing lures, jigs, weights, and inserts formed from granite of different colors and porosities according to the desired function of the object being formed therefrom.

It is a further object of the invention to provide fishing lures, and jigs formed from granite that may readily accept a skirt.

It is a still further object of the invention to provide fishing weights formed from granite wherein an embedded stainless steel wire or the like provides structural integrity.

It is yet another object of the invention to provide fishing weights formed from granite that are porous and readily absorb a fish attractant to be released into the water surrounding the weight.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1a is a side, elevational, cross-sectional, schematic view of a first embodiment of a fishing lure in accordance with the invention;

FIG. 1b is a side, elevational, cross-sectional, schematic view of a second embodiment of a fishing lure in accordance with the invention;

FIG. 2a is a side elevational view of an irregularly shaped fishing lure in accordance with the invention;

FIG. 2b is a top plan view of the fishing lure of FIG. 2a;

FIGS. 3a and 3b are side elevational and end elevational views, respectively, of a lure or jig body having a rectangular body with a chamfered nose;

FIGS. 3c and 3d are side elevational and end elevational views, respectively, of a lure or jig body having a hexagonal body;

FIGS. 3e and 3f are side elevational and end elevational views, respectively, of a lure or jig body having an oval body;

FIG. 4 is a front elevational, cross-sectional, schematic view of a typical jig in accordance with the invention; and

FIG. 5 is a side elevational view of a weight in accordance with the invention.

### DETAILED DESCRIPTION OF THE PREFERRED EMBODIMENT

The present invention provides environmentally friendly fishing lures (including lure heads), jigs, weights, and lure inserts formed from granite of different colors, densities, and degrees of polish. In applications where weight is required, the granite of the novel devices may ne used to replace highly toxic lead.

As previously stated, fishing lures, jigs, and other devices are intended to attract fish to a hook through their visual features, movement in or through the water, sound and vibration generated by their movement, and odor emitted. For brevity, the term lure is used hereinafter to include lures, plugs, jigs, and any other similar fish attracting device. To provide such fish attracting attributes, many lures rely on the use of materials that have a negative environmental impact. Such negative impacts are created by the base material from which lures are constructed and/or from paint, tape, or other materials used to decorate or embellish the body of the lure. Further negative environmental impact come from material, primarily lead, commonly used to control the weight of the fishing lure.

Fishing lures may be self contained devices or may consist of multiple parts. A lure head, as its name implies, is the portion of the lure assembly proceeding first through the water. A lure head may be followed by other lure components.

Granite is an excellent choice of material from which to fashion fishing lures, lure components, and weights. Granite is a common and widely occurring type of intrusive, igneous rock, typically having a medium to coarse grained texture. Depending on their chemistry and mineralogy, granites range from pink to gray to almost black in color. By definition, granite has a color index (i.e. the percentage of the rock made up of dark minerals) of less than 25%. Color indices are believed to be well known to those of skill in the geologic arts and, consequently are not further discussed herein.

Depending on the color, granite also varies in density from approximately 24.9 lb/square foot for black granite (e.g., absolute black granite) 3 cm in thickness to approximately 16 lb/square foot (3 cm in thickness) for light colored granite (e.g., Santa Cecilia granite). It should be noted that these specified densities are for dry granite. Because the density of a particular piece of granite is determined by the granite type (light colored vs. dark colored) and the porosity based upon surface finish may vary, each particular piece will absorb more or less water. Consequently, the effective density of a particular lure or jog body or a weight will vary as different amounts of water may be absorbed compared to a lure, jig, or weight formed from a different color granite or having a different surface finish.

The physical characteristics of granite make it extremely useful for manufacturing fishing lures and other fishing tackle. It is both hard and tough and it's natural appearance, typically streaked, speckled, etc. allows a lure body or other lure component to have an appearance naturally attractive to fish. In addition, reflective constituents of granite, for example, mica, provide natural reflecting features on the lure body. Granite's density is high enough to make lures or lure components that perform properly when the lures are trolled or otherwise moved through the water. The porosity of granite also allows fish attracting agents to be absorbed into the body, especially when one or more sides of a structure remain unpolished.

Perhaps most importantly, unlike lure bodies formed from softer materials, a granite lure is not readily damaged by the strike of a large ocean fish. Fishermen recount tails of expensive lures of the prior art being totally destroyed by the strike of a large fish such as a Wahoo or a Mako Shark.

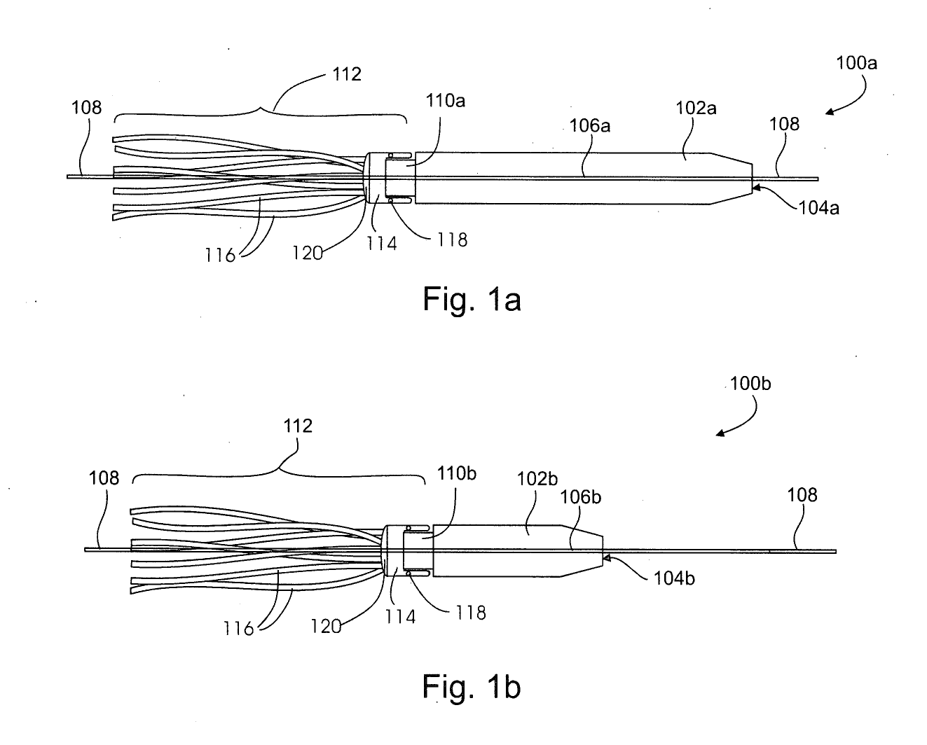

Referring first to FIGS. 1a and 1b, there are shown side elevational, cross-sectional, schematic views of two fishing lures formed from granite in accordance with the invention, generally at reference numbers 100a, 100b.

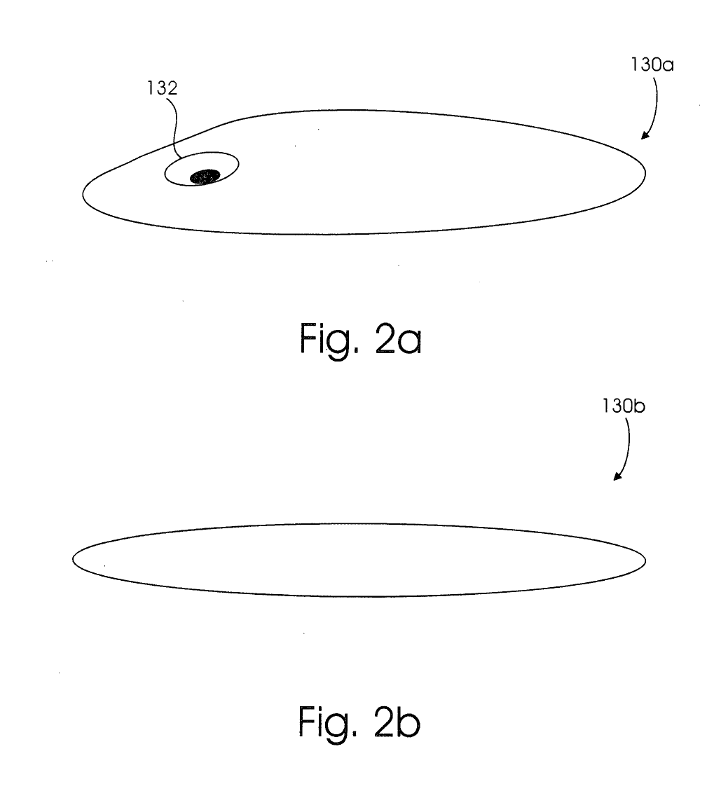

Each fishing lure 100a, 100b has a solid granite body 102a, 102b with respective front ends 104a, 104b. Bodies 102a, 102b may have any of several different cross sections as viewed from front ends 104a, 104b. For example, cross sections may be square, rectangular, hexagonal, or round. Cross sections may, if desired, assume any other shape such as a regular or an irregular polygon. Finally, as may be seen in FIGS. 2a and 2b, a lure body may be shaped to resemble a fish or other living organism.

A slot or groove 106a, 106b is formed along a major axis, not specifically identified, of respective fishing lures 100a, 100b. Grooves 106a, 106b, are typically formed along a centerline using a diamond saw, or similar tool. In other embodiments, a drill or similar tool may be used to drill an axial hole, not shown, through the bodies 102a, 102b. Such holes may replace grooves 106a, 106b. Tools suitable for forming grooves or holes in granite are believed to be well known to those of skill in the art and are not further discussed herein.

Grooves 108a, 108b are sized to allow insertion of chafe resistant tubing 108, hereinafter chafe tubing, into grooves 106a, 106b. Chafe tubing 108 is typically made from nylon or a similar material that is environmentally friendly and provided in a wide range of diameters. Typical outside diameter/inside diameter sizes marketed to the fishing trade includes tubing of 4 mm/2 mm; 5 mm/3 mm; 6 mm/4 mm; and 5 mm/8 mm. Other sizes may also be used to meet a particular operating circumstance or environment. Chafe tubing is believed to be well known to those of skill in the art and is not further discussed herein.

As discussed in more detail hereinbelow, chafe tubing 104 provides attachment points for hooks and/or other ancillary tackle, not shown, as well as allowing lure 100a, 100b to be attached to a line, not shown.

Cement, not specifically identified, is used to affix chafe resistant tubing 108 into grooves 106a, 106b. Typically a two-part acrylic or epoxy resin system has been used. Acrylic resins are typically easier to color treat than are epoxy resin systems. However, epoxy resin systems are currently available in a wide range of colors when cured. An exemplary acrylic cement found suitable for the application is one of several two-part resin systems distributed by AKEMI® North America of Holbrook, N.Y. USA. Resin systems having a transparent, knife grade base are desirable. Specifically, Akemi transparent knife grade polyester supplied as POLY.10711 in 4500 Ml. Containers has been found satisfactory for the application. An epoxy system found suitable is supplied by Superior Adhesives of Byron Center MI as Catalog No. E-1010. The major concerns with choosing the cement (i.e., resin system) are functionality, cured color, and environmental compatibility. There may be other suitable cements known to those of skill in the art and, consequently, the invention is not considered limited to the above-identified cements chosen for purposes of disclosure.

A tail section (e.g., an end shaft) 110a, 110b is affixed to respective ones of granite lure bodies 102a, 102b using mechanisms and/or techniques believed to be well known to those of skill in the art and not further described herein. Typically, tail pieces 110a, 110b have a cylindrical cross section and are cemented to respective bodies 102a, 102b.

A skirt 112 is attached to each of tail sections 110a, 110b. Skirt 112 has collar portion 114 and a plurality of skirting strands 116 forming trailing strands (e.g., “squid tentacles”)

Collar 114 portion is typically cylindrical and formed from silicone rubber or a similar material. Collar portion 114 is attached to tail piece 110a, 110b by sliding it over body 102a, 102b of respective lures 100a, 100b from the fronts 104a, 104b thereof and onto tail piece 110a, 110b. Collar portion 114 may then be secured to tail piece 110a, 110b using a waxed cord 118. Waxed dental floss has been found suitable for the application. It will be recognized that many alternative materials and/or techniques may be used to affix collar portion 114 to tail piece 110a, 110b. Consequently, the invention is not considered limited to a securement comprising wax cord. Rather, the invention is intended to include any stable securement material or method.

Once secured, collar portion 114 is folded back over itself, (i.e., turned inside out) so that skirting strands 116 extend rearwardly and stream from tail piece 110a, 110b.

A hook lock, 120 typically formed from rubber may be attached to a rear surface of tail piece 110a, 110b. Hook locks are believed to be well known to those of skill in the art and are not further described herein.

The color of granite is selected depending upon the particular fish species that the lure is intended to attract. One or more surfaces of the selected granite may be polished to provide a desired degree of reflectivity.

It will be recognized that granite fishing lure bodies 102a, 102b may be provided in a wide range of sizes and shapes. Referring now to FIGS. 2a and 2b there are shown side elevational and top plan schematic view of a lure body 130 designed to reproduce the approximate shape of a bait fish. An eye, shown schematically at reference number 132 or, other desired markings, none shown, may, of course, be added to any of the lure bodies of the present invention.

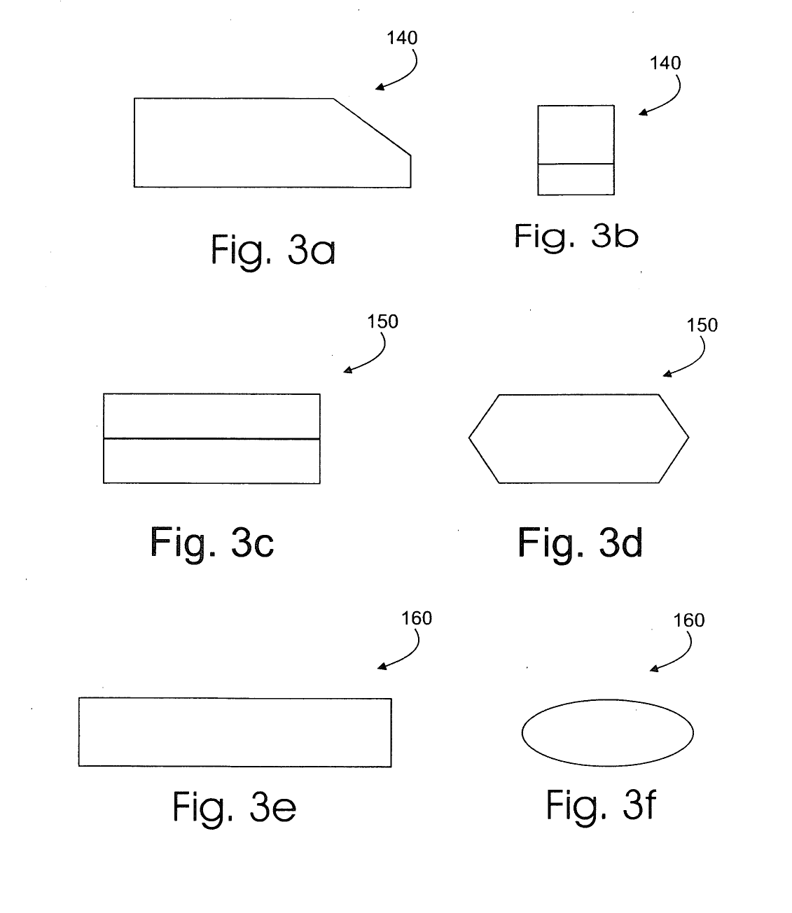

Referring now also to FIGS. 3a and 3b, there are shown side elevational and end elevational schematic views, respectively, of yet another possible lure body shape, generally at reference number 140. Lure body 140 has a substantially rectangular cross section but has a chamfered nose.

Likewise, FIGS. 3c and 3d there are shown side elevational and end elevational schematic views, respectively, of still another possible lure body shape, generally at reference number 150. Lure body 150 has a hexagonal cross section.

FIGS. 3e and 3f show side elevational and end elevational schematic views, respectively, of still another possible lure body shape, generally at reference number 160. Lure body 160 has an oval cross section.

It will be recognized that numerous other body shapes may be chosen. Consequently, the invention is not considered limited to the shapes and/or sizes shown for purposes of disclosure. Rather, the invention includes granite bodies of any size and/or shape, color, and degree of polishing as well as the shapes and sizes chosen for purposes of disclosure.

Like lures, jigs may be formed from granite. Unlike lures, a jig is a fish attracting element designed and adapted to be moved up and down vertically in a water column, usually with little if any horizontal movement. Hooks and other associated tackle are typically attached at the front of a jig whereas in lures the hooks and associated tackle are typically attached at the rear of the lure body. Jigs may use a body shaped to induce wobble as the jig is repeatedly moved up and down in the water.

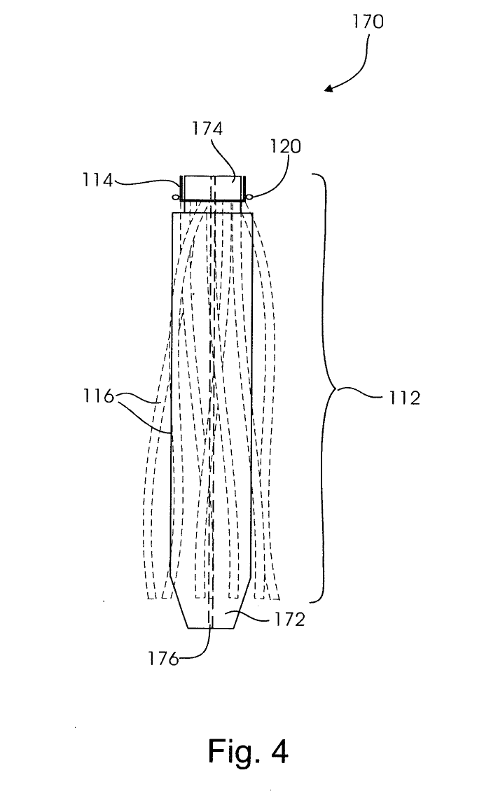

Referring now also to FIG. 4, there is shown a front elevational, cross-sectional, schematic view of a typical jig in accordance with the invention, generally at reference number 170.

Jig body 172 is similar to lure bodies 102a, 102b (FIG. 1). A tail section (i.e., an end shaft) 174 is typically a cylindrical structure affixed to body 172.

Body 172 and tail section 174 have a central through bore penetrating completely therethrough. Through bore 176 may be utilized to affix jig 170 to a line as well as to attach one or more hooks and additional ancillary tackle as desired.

A skirt 112 having a collar 114 is affixed to tail section 174, typically using a waxed cord 120.

Unlike lures 100a, 100b where skirting strands 116 train behind respective lure bodies 102a, 102b, skirting strands 116 surround jig body 172. Skirting strands 116 are shown in broken lines to better reveal construction details of jig 170.

Another class of fishing apparatus for which granite may advantageously be used is fishing weights. As previously mentioned, lead which was for many years the material of choice for fishing weights presents a toxic hazard to the environment, particularly to wildlife therein. Granite weights overcome the toxicity problem of lead and allow the creation of nontoxic weights. Further, the porosity of granite is used effectively to act as a dispensing system for liquid fish attractants that may be inserted directly into the porous body of the weight and subsequently released directly from the weight and dispersed into the surrounding water. Dispersion rates may be controlled by the percentage of the surface area of the weight that is polished. The polishing operation partially seals the polished surface. When a higher amount of dispersion is desired, more surface area may be left unpolished.

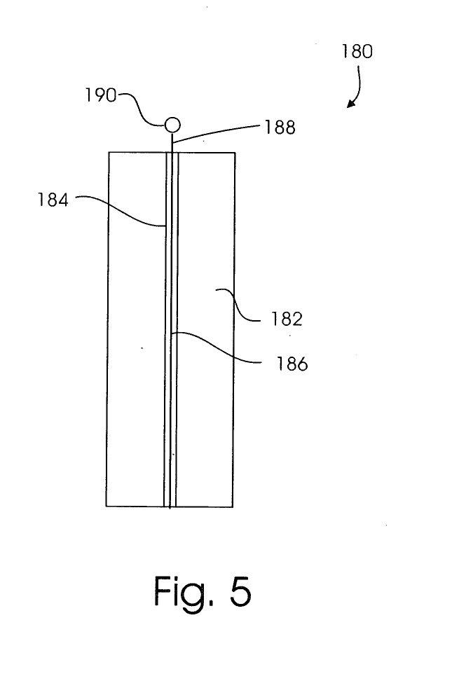

Referring now also to FIG. 5, there is shown a side elevational, cross-sectional, schematic view of a weight in accordance with the invention, generally at reference number 180.

Weight 180 has a substantially rectangular body 182. It will, of course be recognized that body 182 may be formed in any convenient and/or desirable shape as its only purpose is to provide mass.

A central groove 184 is cut in body 182, generally along a major axis thereof.

A stainless steel wire 188 is placed in groove 184. After stainless steel wire 188 is placed in groove 184, cement 186 is placed in groove 184 securing stainless steel wire 188 therein. Suitable cements have been discussed in detail hereinabove. Stainless steel wire 188 provides structural stability to granite body 182 not unlike rebar, not shown, provides to concrete, not shown.

A loop 190 at a proximal end of stainless steel wire 188 allows securing weight 180 to other tackle as required.

A non-toxic, typically organic dye may be used to color entire bodies or to impart fish specific markings to cause the granite body of a granite fishing lure, jig, etc. to resemble a desired bait fish. Color is typically applied to a porous surface of the lure body, typically at a 50-200 grit degree of polish. Final sanding or polish with finer grits, typically up to approximately 3000 grit seals the porous surface and seals the color into the granite body, thereby making the solid color or marking permanent.

One especially useful material which may be used for such treatment is a luminescent (i.e., glow in the dark”) material. Because light levels from the surface drop of rapidly in deep water (e.g., 400 feet and below), a luminescent treatment of the jigs or lures in accordance with the present invention make them much more useful for deep sea fishing applications.

While granite has been chosen for purposes of disclosure, it will be recognized that alternate materials, for example onyx may be chosen to form fishing lures, jigs, etc. Onyx is a translucent stone that glows if illuminated from an interior region of a lure or jig body by a light source. It will be recognized that other light colored stone may likewise be used to fashion fishing lures, jigs, etc.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A fishing lure or jig, comprising:
a) an elongated granite body having a major axis;
b) a groove disposed in said granite body substantially parallel to said major axis;
c) anti-chafe tubing disposed in said groove, said anti-chafe tubing having a proximal end extending beyond a first end of said granite body and a distal end protruding beyond a second, opposing end of said granite body; and
d) cement disposed in said groove and adapted to retain said anti-chafe tubing therein.

2. The fishing lure or jig as recited in claim 1 wherein said granite body is formed from granite selected on the basis of at least one factor selected from the group: granite color, and granite density.

3. The fishing lure or jig as recited in claim 2 wherein said granite body comprises at least one polished exterior surface.

4. The fishing lure or jig as recited in claim 3 wherein said granite body is treated with at least one material selected from the group: a dye and paint prior to forming said at least one polished surface.

5. The fishing lure or jig as recited in claim 4 wherein said at least one material selected from the group: a dye and paint comprises a luminescent material.

6. The fishing lure or jig as recited in claim 4 wherein said granite body is treated with at least one material selected from the group: a dye and paint prior is selectively applied to said granite body in a predetermined pattern.

7. The fishing lure or jig as recited in claim 3 wherein said granite body comprises a first lure body portion and a second lure body portion coaxially aligned with and affixed to said first body portion.

8. The fishing lure or jig as recited in claim 7 wherein said second body portion comprises a cylinder.

9. The fishing lure or jig as recited in claim 8, further comprising:
e) a skirt removably affixed to said cylindrical second body portion.

10. The fishing lure or jig as recited in claim 9, further comprising:
f) a waxed cord disposed to secure said skirt to said cylindrical body portion.

11. The fishing lure or jig as recited in claim 2, wherein said granite body has a cross-sectional shape when viewed from a first end of said granite body along said major axis.

12. The fishing lure or jig as recited in claim 11, wherein a region adjacent said first end of said granite body has a different cross-sectional shape than that of said cross-sectional shape of said granite body.

13. A fishing lure or jig, comprising:
a) an elongated granite body having a major axis, said elongated granite body being formed from granite selected on the basis of at least one factor selected from the group: granite color, and granite density;
b) a through bore disposed in and completely through said granite body substantially parallel to said major axis; and
c) anti-chafe tubing disposed in said through bore, said anti-chafe tubing having a proximal end extending beyond a first end of said granite body and a distal end protruding beyond a second, opposing end of said granite body.

14. The fishing lure or jig as recited in claim 13 wherein said granite body comprises at least one polished exterior surface.

15. The fishing lure or jig as recited in claim 14 wherein said granite body is treated with at least one material selected from the group: a dye and paint prior to forming said at least one polished surface.

16. The fishing lure or jig as recited in claim 15 wherein said at least one material selected from the group: a dye and paint comprises a luminescent material.

17. The fishing lure or jig as recited in claim 16 wherein said granite body is treated with at least one material selected from the group: a dye and paint prior is selectively applied to said granite body in a predetermined pattern.

18. The fishing lure or jig as recited in claim 14 wherein said granite body comprises a first lure body portion and a second lure body portion coaxially aligned with and affixed to said first body portion.

19. The fishing lure or jig as recited in claim 18 wherein said second body portion comprises a cylinder.

20. The fishing lure or jig as recited in claim 19, further comprising:
e) a skirt removably affixed to said cylindrical second body portion.

21. The fishing lure or jig as recited in claim 20, further comprising:
f) a waxed cord disposed to secure said skirt to said cylindrical body portion.

22. The fishing lure or jig as recited in claim 16, wherein said granite body has a cross-sectional shape when viewed from a first end of said granite body along said major axis.

23. The fishing lure or jig as recited in claim 22, wherein a region adjacent said first end of said granite body has a different cross-sectional shape than that of said cross-sectional shape of said granite body.

24. An elongated weight for use with a fishing lure or jig, comprising:
a) an elongated granite body having a major axis, said elongated granite body being formed from granite selected on the basis of at least one factor selected from the group: granite color, and granite density;
b) a central groove disposed on a surface of said granite body substantially parallel to said major axis;
c) a metal wire disposed in said groove, said metal having a proximal end extending beyond a first end of said granite body;
d) cement disposed in said grove and securing said metal wire therein; and
e) an attachment loop formed in said metal wire proximate said proximal end thereof.

25. The elongated weight for use with a fishing lure or jig as recited in claim 24, wherein said metal wire comprises a stainless steel wire.

26. The elongated weight for use with a fishing lure or jig as recited in claim 14, wherein said granite body comprises at least one unpolished surface adapted to receive and absorb a fish attracting substance.

27. The elongated weight for use with a fishing lure or jig as recited in claim 26 wherein said granite body is treated with at least one material selected from the group: a dye and paint prior to forming said at least one polished surface.

28. The elongated weight for use with a fishing lure or jig as recited in claim 27 wherein said at least one material selected from the group: a dye and paint comprises a luminescent material.

29. The elongated weight for use with a fishing lure or jig as recited in claim 28 wherein said granite body is treated with at least one material selected from the group: a dye and paint prior is selectively applied to said granite body in a predetermined pattern.
